(19) United States
(12) Patent Application Publication
(10) Pub. No.: US 2026/0233592 A1
(43) Pub. Date: Aug. 13, 2026

(54) VEHICLE AND PANEL ASSEMBLY

(71) Applicant: Polyplastic B.V., Rotterdam (NL)

(72) Inventors: Biem Pieter Wibbens, Rotterdam (NL); Bianca Catharina Van Bemmel-Welle, Rotterdam (NL)

(21) Appl. No.: 19/470,831

(22) PCT Filed: Mar. 29, 2024
(86) PCT No.: PCT/IB2024/053076

§ 371 Date: Sep. 30, 2025

(30) Foreign Application Priority Data
Mar. 31, 2023 (NL) 2034483

(51) Int. Cl. B60J 7/11; B62D 35/00

(52) U.S. Cl. CPC B60J 7/11; B62D 35/00

(57) ABSTRACT

A vehicle, particularly a recreational vehicle, comprises a living space bounded by a roof (1), wherein a roof opening (10) is provided in the roof and a panel (30), particularly a sunroof, is arranged at the position of the roof opening. An adapter device (20) is arranged on the roof externally of the roof opening for the purpose of receiving and mounting the panel. The adapter device comprises a central part (22) which is flanked by a set of peripheral parts (24). The peripheral parts (24) extend over closed roof segments on either side of the roof opening (10). The panel (30) is connected to each of the peripheral parts of the adapter device from the outside by means of at least one manually releasable snap connection. The panel is connected to the central part of the adapter device from the inside by means of a mechanical further connection.

The present invention relates to a vehicle, particularly a recreational vehicle, comprising a living space bounded by a roof, wherein a roof opening is provided in the roof and a panel, particularly a sunroof, is arranged at the position of the roof opening, and wherein an adapter device is arranged on the roof externally of the roof opening for the purpose of receiving and mounting the roof panel, which adapter device comprises a central part which is flanked by a set of peripheral parts of the adapter device.

Such a vehicle is for instance known from a French patent application 3.089.158. In the recreational vehicle described therein a roof opening is forced in the roof between the A-pillar and the B-pillar of a van. At the position of the roof opening an adapter frame is subsequently arranged all around the roof opening, this adapter frame having a recess for receiving a transparent roof window. The adapter frame is glued permanently to the vehicle roof, and the adapter frame is also permanently adhered to the window.

A drawback of this known construction is however that, if the frame is damaged, particularly broken, repair or replacement thereof is a major operation. If it is not only the glued window but also the glued adapter frame that requires replacement, this entails a significant risk of damage to the vehicle.

The present invention has for its object, among others, to provide a vehicle with a roof panel, particularly a roof window, which can if desired be replaced in less time-consuming manner when damaged.

In order to achieve the stated object a vehicle of the type described in the preamble has the feature according to the invention that the peripheral parts of the adapter device externally of the roof extend over closed roof segments on either side of the roof opening, that the panel is connected outside the roof opening to each of the peripheral parts of the adapter device from the outside by means of at least one manually releasable snap connection, and that the panel is connected to the central part of the adapter device from the inside by means of a mechanical further connection.

The invention thus provides an overdimensioned adapter device which extends with a set of peripheral parts thereof outside the roof opening. It can be glued reliably to the roof surface there. The panel is connected to this part of the adapter device by means of a releasable snap connection. This is a blind attachment that can nevertheless be removed at any time by manually breaking the snap connection, after the mechanical connection to the central part of the panel was broken from the inside beforehand. This latter connection is located inside the roof opening and thereby remains accessible via the roof opening.

In this way all attachments between the adapter device and the panel remain accessible or at least breakable, whereby the panel also always remains exchangeable, even after some time. This minimizes the changes in tolerances necessary, for instance due to changes in production. The panel can be mounted and, if desired, removed wholly mechanically. A preferred embodiment of the vehicle has for this purpose the feature that the mechanical connection is brought about by means of one or more screw members.

In order to camouflage the possibly marring mechanical connection and also provide a finish for the rest of the roof opening a further preferred embodiment of the vehicle has the feature that an opaque edge finish, which conceals the mechanical connection from view, is arranged internally, adjacently of the roof opening. This edge finish particularly comprises a blind system which covers the mechanical attachment between the adapter device and the panel and so conceals it from view from the inside.

The snap connection between the panel and the adaptor device can per se be embodied in various ways. In a particular embodiment the vehicle according to the invention is however characterized in that the at least one snap connection comprises in each case a receiving cavity and a snap member receivable therein. A further preferred embodiment of the vehicle has the feature here according to the invention that the at least one snap cavity is formed integrally in the panel. As integral part of the panel, the cavity can not only be provided in particularly practical manner but can moreover take a particularly strong and robust form.

In a particular embodiment the vehicle according to the invention is however characterized in that the at least one snap member comprises in each case an elongate body which forms part of the adaptor device and is received laterally in the snap cavity with an axial freedom of movement. The snap member here snaps laterally into the cavity, which snaps with a wall thereof around the snap member. The wall here particularly engages over a limited portion of the elongate snap member, which therefore allows a tolerance for a certain expansion or shrinkage of the panel in the longitudinal direction of the snap member.

With a view to strength and to limiting a sliding resistance a further preferred embodiment of the vehicle has in this respect the feature that the elongate body comprises a metal body which is received on opposite outer ends in the adapter device. In a preferred embodiment the vehicle is here characterized in that the at least one snap member comprises a first set of elongate bodies, as well as a second set of elongate snap members, wherein the first set and the second set are oriented transversely of each other. The snap connection thus provides a tolerance for expansion or shrinkage of the panel in both orthogonal directions.

A further particular embodiment of the vehicle has the feature that the panel is double-walled, comprising an inner shell and an outer shell maintaining an intermediate space relative to each other, wherein the inner shell comprises the at least one snap cavity. Besides an increased thermal insulation, this double-wall construction of the panel furthermore imparts an increased rigidity of form to the panel, enabling the shells to be thinner while retaining their strength. The panel is preferably embodied aerodynamically in order to limit a travelling resistance and noise level of and in the vehicle, respectively.

In a further particular embodiment the vehicle according to the invention is characterized in that the adaptor device comprises all around the roof opening a raised edge on which the panel is received. The upright edge provides externally an attractive edge finish all around the opening in the vehicle roof, and furthermore a particularly practical mounting base on which the panel is received. With a view to an adequate water barrier, a further particular embodiment of the vehicle has the feature here that a water-obstructing seal is provided between the edge and the window, particularly a sealing profile, more particularly a sealing profile of an optionally natural sealing rubber. Such a sealing profile can particularly also be applied for the purpose of a removable panel which can be adjusted between a closed and one or more partially opened positions.

In order to allow for entry of more daylight into the space a consequently in-demand embodiment of the vehicle according to the invention has the feature that the panel comprises a sunroof formed from a transparent plastic, particularly from poly(methyl methacrylate) (PMMA) or polycarbonate. The transparent window particularly extends all the way over the roof opening in the roof and so allows for maximal additional entry of sunlight.

The adapter device can optionally be made almost completely integrally and moreover be utilized to conceal the part of the roof with therein the roof opening, which lies thereunder, from view. With this in mind, a further particular embodiment of the vehicle according to the invention has the feature that the adapter device comprises at least substantially an opaque plastic body, particularly an injection moulded body or deep-drawn body of a thermoplastic plastic, more particularly of a plastic such as polypropylene, polyethylene, acrylonitrile butadiene styrene (ABS) or acrylonitrile styrene acrylate (ASA). In a preferred embodiment the vehicle is here characterized in that outermost edges of the peripheral parts of the adapter device reach at least substantially to opposite longitudinal sides of the roof. In this case the roof is covered over the whole width thereof with and therefore protected by the assembly of adapter device and the panel mounted thereon.

The adapter device preferably comprises an aerodynamic spoiler behind which the panel is received. The spoiler reduces the overall air resistance and also the travelling noise of the assembly. The adapter device further advantageously comprises a raised peripheral edge, wherein a downward hanging wall, which is in register with the peripheral edge of the adapter device, is formed on the panel.

The invention also relates to an assembly of the above described adapter device with therein the above described panel, particularly a window, and will be further elucidated here with reference to an exemplary embodiment and an accompanying drawing. In the drawing:

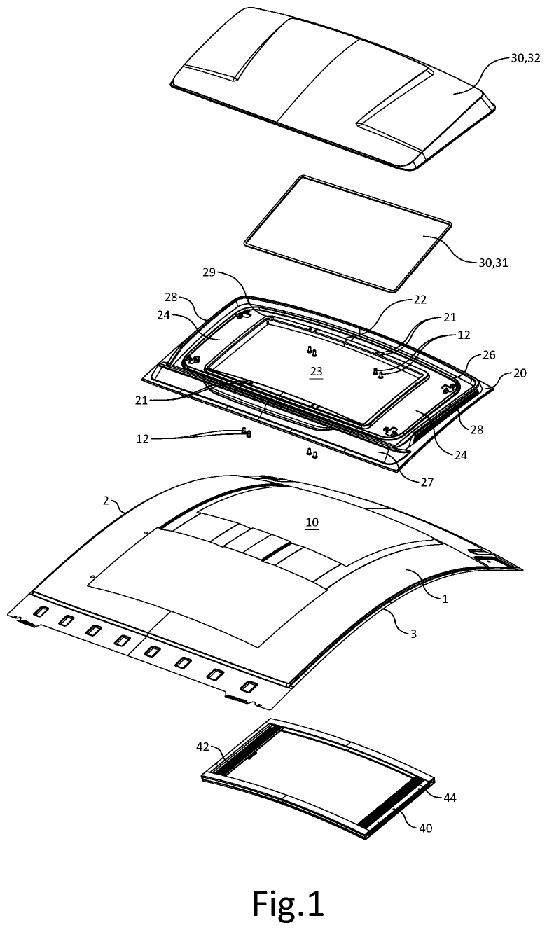

FIG. 1 is an exemplary embodiment of a part of a vehicle according to the invention with a roof window mounted in a roof thereof;

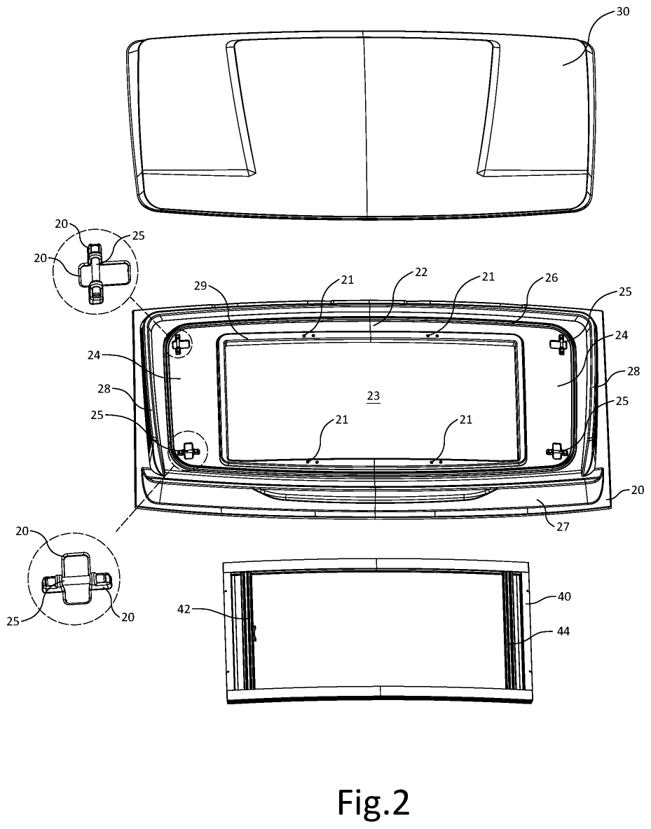

FIG. 2 is an exploded view of the adapter device and the window together with the roof of FIG. 1;

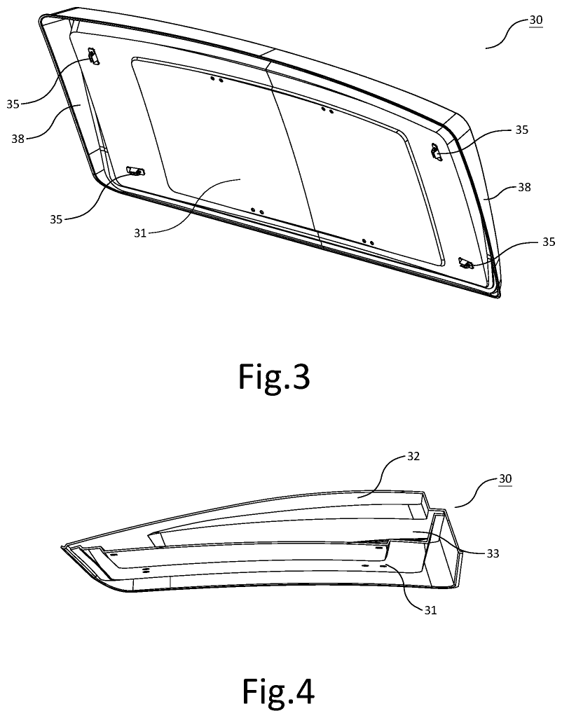

FIG. 3 is a bottom view of the window applied in the assembly of FIG. 2; and

FIG. 4 is a cross-section of the window of FIG. 3.

It is otherwise noted here that the figures are purely schematic and not always drawn to (the same) scale. Some dimensions in particular may be exaggerated to greater or lesser extent for the sake of clarity. Corresponding parts are designated in the figures with the same reference numeral.

FIGS. 1 and 2 show a front part of a roof 1 of a vehicle in which a sunroof is received according to the invention between the windscreen (not shown), under the shown part of roof 1, and an A-pillar of the vehicle, roughly halfway along the shown part of roof 1. For this purpose a roof opening 10, see also FIG. 2, is provided in the original roof 1 and mounted on an outer side of roof 1 at the position of an adapter device 20. The adapter device is composed wholly by thermoforming or injection moulding from a suitable, optionally transparent or translucent plastic. In this embodiment use is in this respect made of an opaque plastic, such as polypropylene, polyethylene, acrylonitrile butadiene styrene (ABS) or acrylonitrile styrene acrylate (ASA), from which the adapter device 20 is formed by injection moulding in a single manufacturing operation. Adapter device 20 serves as mounting base for the final window 30.

The roof opening 10 is finished internally with an edge finish 40 in the form of a frame which extends all around roof opening 10 and optionally provides space for a blackout blind 42 and/or insect screen 44. The shown embodiment is based on a van, such as a Ford Transit or similar van, which has been or will be converted into a recreational vehicle, usually referred to as camber, mobile home, camper van or van conversion.

As will become readily apparent from the figures, adapter device 20 comprises a central part 22 in which a recess 23 is provided correspondingly to the roof opening 10 in roof 1. The adapter device 20 comprises on either side of the central part 22 a set of peripheral parts 24, each extending externally over closed roof segments on either side of the roof opening 10 in roof 1. The peripheral parts 24 extend here substantially to opposite longitudinal sides 2, 3 of roof 1, which is thus taken up over its whole width by the adapter device 20 with the window 30 therein, as is visible particularly in FIG. 1.

Adapter device 20 is connected permanently to roof 1 by means of a suitable adhesive, mastic or welded connection, wherein it is particularly the two peripheral parts 24 that provide a spacious support surface. For the purpose of arranging an adhesive and/or mastic bead an adhesive channel is over at least substantially a whole outline provided in the adapter device on a side thereof directed toward the vehicle. The adapter device is hereby permanently glued to the vehicle along this whole outline. Adapter device 20 is furthermore connected mechanically to the roof 1 of the vehicle from the inside. For this purpose adapter device 20 comprises on the side directed toward the vehicle a set of legs (studs) formed thereon. These fall into openings provided for this purpose in the roof outside of roof opening 10. Internal screws with cones are placed on the studs, whereby the sheet metal of the vehicle and the adapter device are pulled toward each other. A cohesive and extremely stable whole is thus obtained.

In order to be able to optionally replace the window with relative ease and without risk of damaging the vehicle in the event that window 30 is damaged, window 30 is coupled mechanically to adapter device 20 by means of manually releasable connections. Window 30 is here coupled to adapter device 20 from the outside in the peripheral parts 24 by means of a manually releasable blind snap connection 25, 35. The snap connection 25 is brought about between snap cavities 35 formed in the window on a rear side and in each case a snap member 25 which is receivable therein and forms part of adapter device 20.

In order to enable tension-free accommodation of any stretching or shrinkage of window 30 here as far as possible use is for snap members 25 made of elongate bodies which are received in snap cavities 35 with an axial freedom of movement. In this embodiment use is made for this purpose of stainless steel bars 25 which are accessible between their outer ends to enable them to there be received laterally in the corresponding snap cavity 35 in window 30. Pins 25 are received at their opposite end surfaces in recesses provided in adapter device 20 for this purpose.

As shown in FIGS. 2 and 3, a first set of bars 25 extends here roughly in the longitudinal direction of the vehicle, while a second set of bars 25 is placed crosswise transversely thereof, i.e. roughly in a width direction of the vehicle. The one set of bars thus imparts a certain freedom of expansion and shrinkage to window 30 in the longitudinal direction of the vehicle and the other set a similar freedom of movement in the direction transversely thereof.

Window 30 is mounted, from the inside, by means of a set of screw members 12 in threaded cavities 21 provided in the adapter device for this purpose. The screws 12 used for this purpose can be screwed directly into the material of window 30 via the threaded cavities 21. Fittings adapted thereto can for this purpose also be received in the window and/or the adapter device at the intended location. The opaque framework of the as yet to be arranged edge finish 40 finally conceals these screw members from view, while edge finish 40 is arranged removably so as to be able to provide access to screw members 12 at any time.

In this embodiment the edge finish 40 comprises a blind system in the form of a frame composed of aluminium profiles in which is movable a pleated blackout blind and optionally an insect screen. The blind can be closed over the opening manually as needed by means of a pull bar or other type of handle. This blind system is finished with a cover frame which connects the blind frame both mechanically and aesthetically to the original roof of the cab of the vehicle.

The adapter device 20 comprises all around recess 23 and the roof opening 10 lying inside it a raised edge 26 on which central part of window 30 is received. The peripheral edge 26 provides here a defined mounting base for an adequate water barrier which provides for water-tightness. The water barrier comprises here an elastic U-shaped sealing profile with a sealing bead of an optionally natural rubber thereon. From the inside this edge 26 moreover provides a cavity into which edge finish 40 disappears in wholly or partially recessed manner. Inside water barrier 26 a further peripheral rib 29 also extends all around opening 10. This rib 29 provides a raised edge as visible boundary of roof opening 10. If desired, an additional seal can be provided thereon, such as for instance a foam band, to serve as acoustic barrier and sound-proofing.

The adapter device further comprises a spoiler 27 formed therein for the purpose of a more aerodynamic transition to the window 30 to be mounted therebehind. Window 30 falls with a wall 38 hanging downward therefrom, see also FIG. 3, around or over a peripheral edge 28 of adapter device 20, which, besides increased stability, also provides for an automatic mutual alignment between window 30 and adapter device 20.

FIG. 3 shows the window 30 separately from a rear side. As can be seen therein, window 30 is double-walled. Window 30 thus comprises a relatively flat inner shell 31 on which the snap cavities 35 are formed as integral part, and a more aerodynamically formed outer shell 32 which saves in a central part a certain intermediate space 33 as insulating cavity relative to the inner shell 31. The outer shell moreover provides on the rear side the downward hanging wall 38 which is in register with the peripheral edge 28 of the adapter device. Both the inner shell and the outer shell are manufactured wholly by thermoforming from a suitable transparent plastic, such as in this embodiment by vacuum forming, deep-drawing or injection moulding from poly(methyl methacrylate) (PMMA). Another suitable plastic is for example polycarbonate (PC).

Although the invention has been further elucidated above with reference to only a single exemplary embodiment, it will be apparent that the invention is by no means limited thereto. On the contrary, many variations and embodiments are still possible within the scope of the invention for a person with ordinary skill in the art. The embodiment is thus based on a transparent, fixedly mounted sunroof, but the same or a similar adapter device can also be used for an openable window or an opaque panel, such as for instance a baggage hatch.

In the embodiment the snap members form part of the adapter device, while the corresponding snap cavities are formed in or on the window. The snap cavities can instead be formed in the adapter device and the snap members provided on the window or panel. A combination or hybrid of the two is likewise possible, wherein each of the two parts will comprise both snap cavities and snap members.

In the embodiment the snap members are connected non-releasably to the adapter device. It is instead also possible to provide between the snap members and the adapter device a, preferably restorable, detachable break connection, which can be used as a last resort to separate the panel from the adapter device in the event that a snap connection fails. In this case the break resistance of the breakable connection that is considerably greater than the intended resistance of the snap connection is opted for.

1. A vehicle comprising a living space bounded by a roof, wherein a roof opening is provided in the roof and a panel, particularly a-sunroof, is arranged at the position of the roof opening, and wherein an adapter device is arranged on the roof externally of the roof opening for the purpose of receiving and mounting the panel, which adapter device comprises a central part which is flanked by a set of peripheral parts of the adapter device, wherein the peripheral parts of the adapter device externally of the roof extend over closed roof segments on either side of the roof opening, wherein the panel is connected outside the roof opening to each of the peripheral parts of the adapter device from the outside by means of at least one manually releasable snap connection, and wherein the panel is connected to the central part of the adapter device from the inside by means of a mechanical further connection.

2. The vehicle according to claim 1, wherein the mechanical connection is brought about by means of one or more screw members.

3. The vehicle according to claim 1, wherein an opaque edge finish, which conceals the mechanical connection from view, is arranged internally, adjacently of the roof opening.

4. The vehicle according to claim 1, wherein the at least one snap connection comprises in each case a receiving cavity and a snap member receivable therein.

5. The vehicle according to claim 4, wherein the at least one snap cavity is formed integrally in the panel.

6. The vehicle according to claim 4, wherein the at least one snap member comprises in each case an elongate body which forms part of the adaptor device and is received laterally in the snap cavity with an axial freedom of movement.

7. The vehicle according to claim 6, wherein the elongate body comprises a metal body which is received on opposite outer ends in the adapter device.

8. The vehicle according to claim 6 or 7, wherein the at least one snap member comprises a first set of elongate bodies, as well as a second set of elongate snap members, wherein the first set and the second set are oriented transversely of each other.

9. The vehicle according to claim 5, wherein the panel is double-walled, comprising an inner shell and an outer shell maintaining an intermediate space relative to each other, wherein the inner shell comprises the at least one snap cavity.

10. The vehicle according to claim 1, wherein the adaptor device comprises all around the roof opening a raised edge on which the panel is received.

11. The vehicle according to claim 9, wherein a water-obstructing seal is provided between the edge and the window.

12. The vehicle according to one or more of the preceding claims, wherein the panel comprises a sunroof formed from a transparent plastic.

13. The vehicle according to claim 1, wherein the adapter device comprises at least substantially an opaque plastic body.

14. The vehicle according to claim 1, wherein outermost edges of the peripheral parts of the adapter device reach at least substantially to opposite longitudinal sides of the roof.

15. The vehicle according to claim 1, wherein the adapter device comprises an aerodynamic spoiler behind which the panel is received.

16. The vehicle according to according to claim 1, wherein the adapter device comprises a raised peripheral edge and that a downward hanging wall, which is in register with the peripheral edge of the adapter device, is formed on the panel.

17. An assembly of an adapter device and panel received therein, as applicable in the vehicle according to claim 1.

18. The vehicle according to claim 1, wherein the vehicle is a recreational vehicle.

19. The vehicle according to claim 1, wherein said panel comprises a sunroof.

20. The vehicle according to claim 11, wherein said seal comprises a sealing profile of a natural or synthetic sealing rubber.

21. The vehicle according to claim 12, wherein said plastic comprises poly(methyl methacrylate) (PMMA) or polycarbonate.

22. The vehicle according to claim 13, wherein said adapter device comprises an injection moulded body or deep-drawn body of a thermoplastic plastic

23. The vehicle according to claim 13, wherein said plastic comprises polypropylene, polyethylene, acrylonitrile butadiene styrene (ABS) or acrylonitrile styrene acrylate (ASA).
